(19) United States
(12) Patent Application Publication
(10) Pub. No.: US 2014/0219289 A1
(43) Pub. Date: Aug. 7, 2014

(54) HANDLING STACKING LINK FAILURES IN MDC DEVICE

(71) Applicant: Hangzhou H3C Technologies Co., Ltd., Hangzhou (CN)

(72) Inventors: Ke Ye, Beijing (CN); Shixing Chen, Beijing (CN)

(73) Assignee: Hangzhou H3C Technologies Co., Ltd., Hangzhou (CN)

(21) Appl. No.: 14/106,069

(22) Filed: Dec. 13, 2013

(30) Foreign Application Priority Data
Feb. 4, 2013 (CN) 201310042223.X

(51) Int. Cl. H04L 12/911

(52) U.S. Cl. CPC H04L 47/781
USPC 370/420

(57) ABSTRACT

A part of a non-default multitenant device context (MDC) is located on a member device of that forms part of a logical network device. The non-default MDC part assigns a first downlink port to a first downlink port group, assigns a first uplink port to a first uplink port group, and monitors a stacking port to another part of the non-default MDC on another member device that forms part of the logical network device. When the stacking port changes to the down state, the non-default MDC part determines if the first downlink port group and the first uplink port group are in the up state. If so, the non-default MDC part maintains the states of the ports in the first downlink port group and the first uplink port group. Otherwise the non-default MDC part makes changes so the ports in the first downlink port group and the first uplink port group are in the down state.

### CROSS-REFERENCE TO RELATED APPLICATIONS

This application claims priority to CN Patent Application No. 201310042223.X, filed on Feb. 4, 2013, entitled “A Method and Device for Stack Link Fault Processing in the IRF System,” which is incorporated herein by reference.

### BACKGROUND

Virtualization technology, such as intelligent resilient framework (IRF) and virtual switching system (VSS), allows multiple network devices to be combined into a logical network device after necessary configurations. The resulting logical network device offers streamlined management, high reliability, and powerful network expansion capability.

Virtualization technology, such as multitenant device context (MDC) and virtual device context (VDC), enables multi-tenancy on a network device. Using such a technology, a network device can be virtualized and segmented into logical network devices with each logical network device having its own tenants. The resulting logical network devices offer more control and better utilization of the physical hardware resources, increased resiliency with complete isolation of tenants, simplified management and operations, and secure operating environment for all tenants.

### BRIEF DESCRIPTION OF THE DRAWINGS

In the drawings:

FIG. 1 is a block diagram illustrating of a system including two or more physical network devices virtualized to form a logic network device, such as an intelligent resilient framework (IRF) virtual device, which is further virtualized to form logical network devices, such as multitenant device context (MDC) devices, in examples of the present disclosure;

FIG. 2 is a block diagram of the system of FIG. 1 in examples of the present disclosure;

FIG. 3 is a flowchart of a method for a part of a non-default MDC device (hereafter “non-default MDC part”) on a member device of a virtual device to use link monitoring to handle stacking link failures in examples of the present disclosure;

FIG. 4 is a block diagram illustrating a scenario where a non-default MDC part on a member device of a virtual device practicing the method of FIG. 3 in examples of the present disclosure;

FIG. 5 is a block diagram of a system where a link monitor group is without any uplink port in examples of the present disclosure;

FIG. 6 is a flowchart of a method for a non-default MDC part on a member device of a virtual device to use link monitoring to handle stacking link failures in examples of the present disclosure;

FIG. 7 is a block diagram illustrating a scenario where a non-default MDC part on a member device of a virtual device practices the method of FIG. 6 in examples of the present disclosure;

FIG. 8 is a flowchart of a method for a non-default MDC part on a member device of a virtual device to use link monitoring to handle stacking link recoveries in examples of the present disclosure;

FIG. 9 is a block diagram of an apparatus to implement a non-default MDC part on a member device of a virtual device in examples of the present disclosure; and

FIG. 10 is a block diagram of a computing device to implement a non-default MDC part on a member device of a virtual device in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on.

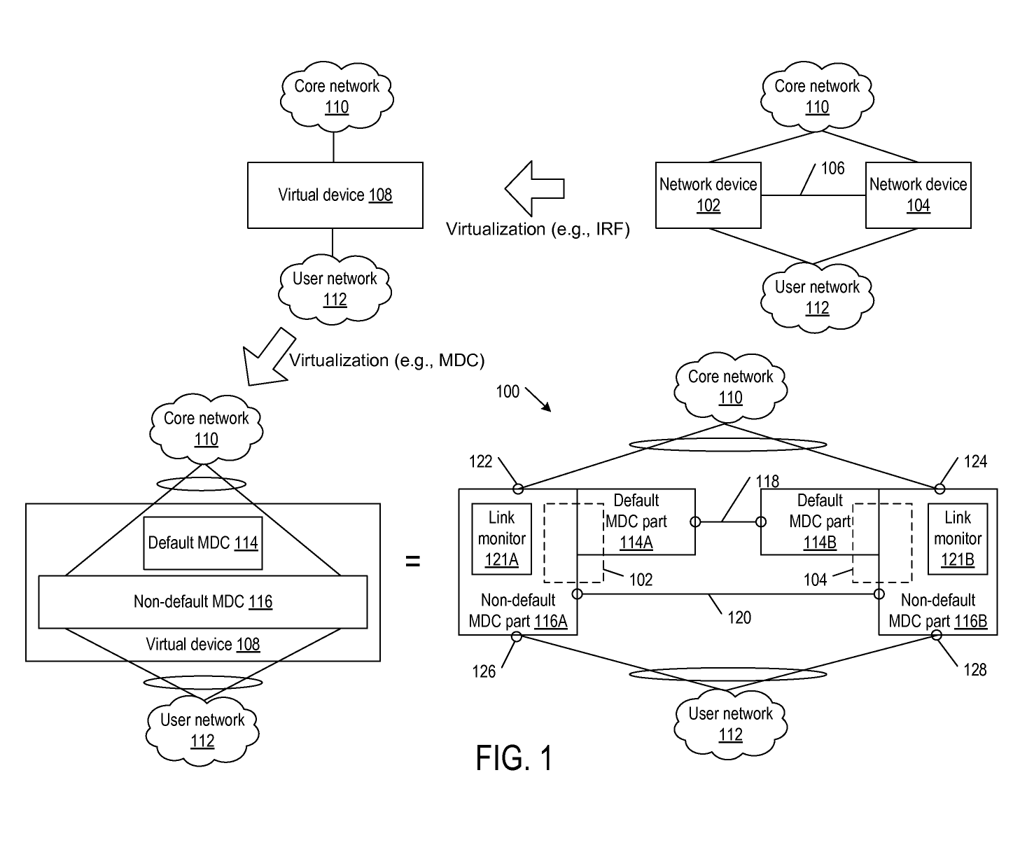

FIG. 1 is a block diagram illustrating a system 100 including two or more physical network devices virtualized to form a logical network device, such as an intelligent resilient framework (IRF) virtual device, which is further virtualized to form logical network devices, such as multitenant device context (MDC) devices, in examples of the present disclosure. Initially two or more physical network devices are stacked to form a virtual device. For example, physical network devices 102 and 104 are stacked via at least one stacking link 106 to form a virtual device 108 (e.g., an IRF virtual device). Network devices 102 and 104 are also referred to as member devices of virtual device 108. Member devices 102 and 104 may be switches or routers each having a stacking port connected to form stacking link 106, and one or more uplink ports connected to an upstream network 110 (e.g., a core network) and one or more downlink ports connected to a downstream network 112 (e.g., a user network).

Virtual device 108 is virtualized into two or more MDC devices including a default MDC device 114 and one or more non-default MDC devices, such as a non-default MDC device 116. Each MDC device provides an independent forwarding service, and link aggregation is applied to both uplink and downlink ports for load balancing. Each MDC device is a grouping of ports with both the control and data planes isolated from other MDC devices. Each MDC device has its own configuration, forwarding and routing tables, and management.

Parts of the same MDC device may be implemented on different member devices and communicate through a stacking link (e.g., an IRF stacking link). For example, one part 114A of default MDC device 114 (hereafter “default MDC part 114A”) is implemented on member device 102 and another part 114B of default MDC device 114 (hereafter “default MDC part 114B”) is implemented on member device 104. Default MDC parts 114A and 114B communicate through at least one stacking link 118 (e.g., an IRF stacking link that may also be referred to as “default MDC stacking link”). Default MDC parts 114A and 114B each has a stacking port connected to form stacking link 118.

One part 116A of non-default MDC device 116 (hereafter “non-default MDC part 116A”) is implemented on member device 102 and another part 116B of non-default MDC device 116 (hereafter “non-default MDC part 116B”) is implemented on member device 104. Non-default MDC parts 116A and 116B communicate through at least one stacking link 120 (e.g., an IRF stacking link that may also be referred to as “non-default MDC stacking link”). Non-default MDC parts 116A and 116B each has a stacking port connected to form stacking link 120. Stacking links 118 and 120 may be implemented with stacking link 106 and an additional stacking link connected between member devices 102 and 104.

When a stacking link in a non-default MDC fails and a multi-active detection (MAD) technique is used to handle such a failure, one part of the non-default MDC device is selected as a conflicting part and all the ports on the conflicting part are disabled. This forces the traffic to the remaining non-conflicting part of the non-default MDC device and cuts the overall throughput by half. Thus, in examples of the present disclosure, a non-default MDC device uses a link monitoring technique to lessen the impact of stacking link failures. In FIG. 1, non-default MDC parts 116A and 116B use respective link monitors 121A and 121B to implement the link monitoring mechanism.

In examples of the present disclosure, a link monitoring technique may be implemented as follows. A non-default MDC part assigns a first downlink port of the non-default MDC part to a first downlink port group, assigns a first uplink port of the non-default MDC part to a first uplink port group associated with the first downlink port group, and monitoring a stacking port connected to a stacking link to another non-default MDC part. When the stacking port changes to a down state, the non-default MDC part determines if the first downlink port group and the first uplink port group are both in an up state. In one example, a port group is in the up state when all ports in that port group are in the up state, or otherwise the port group is in the down state. In another example, a port group is in the up state when at least one port in that port group is in the up state, or otherwise the port group is in the down state. When the first downlink port group and the first uplink port group are both in the up state, the non-default MDC part maintains ports in the first downlink port group and the first uplink port group in the up state. When the first downlink port group and the first uplink port group are not both in the up state, the non-default MDC part makes changes so the ports in the first downlink port group and the first uplink port group are in the down state. Thus, unlike the MAD technique, the link monitoring technique does not always shut down all ports the non-default MDC part when the stacking port changes to the down state. Instead, the link monitoring technique maintains the states of the ports in corresponding downlink and uplink port groups if both port groups are all in the up state so they continue to forward data, thereby reducing the impact a stacking link fault an MDC device.

The non-default MDC part may assign a second downlink port of the first part of the non-default MDC device to a second downlink port group. When the stacking port changes to the down state, the non-default MDC part may determine that there is no uplink port associated with any port in the second downlink port group and then make changes so ports in the second downlink port group are in the down state.

The first down link port group and the second downlink port group may be control groups of a first link monitor group, and the stacking port may be a monitor port of the first link monitor group. The second down link port group may be a control group of a second link monitor group, and the stacking port may be the monitor port of the second link monitor group.

In some examples of the present disclosure, the link monitoring technique may be premised on the following. First, a non-default MDC device separates control from data. For example, non-default MDC device 116 uses its stacking link 120 as a data link to communicate data between its non-default MDC parts 116A and 116B located on different member devices 102 and 104. Default MDC 114 shares its stacking link 118 with non-default MDC device 116, which uses stacking link 118 as a control link to synchronize control information in MDC part 116 and virtual device 108.

Second, after link aggregation is applied to the uplinks to an upstream network, the downlinks to a downstream network, or both the uplinks and the downlinks, each non-default MDC part prefers to forward traffic using ports on its own side at its own member device over forwarding traffic through the stacking link to the ports on the other non-default MDC part on the other side at the other member device. For example, uplink ports 122 and 124 to upstream network 110 on respective non-default MDC parts 116A and 116B are aggregated, and downlink ports 126 and 128 to downstream network 112 on respective non-default MDC parts 116A and 116B are aggregated. Non-default MDC part 116B then forwards traffic using uplink port 124 and downlink port 128 on its side at member device 104 unless uplink port 124 or downlink port 128 goes down. When that occurs, non-default MDC part 116B would forward traffic over stacking link 120 to non-default MDC part 116A, which would forward traffic using uplink port 122 or downlink port 126 on its side at member device 102.

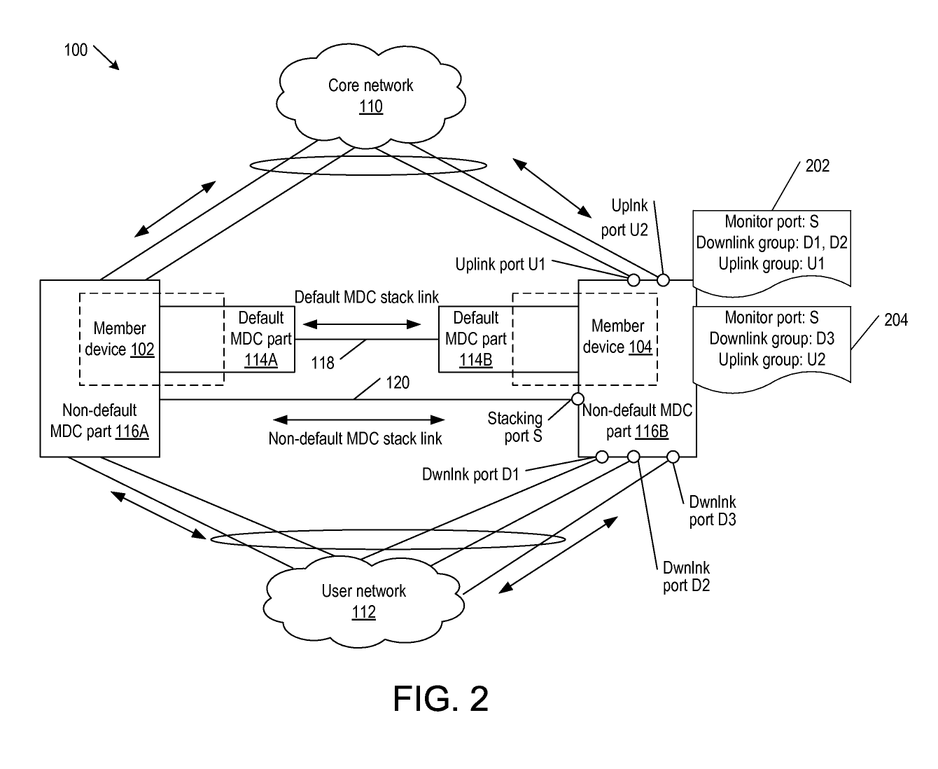

FIG. 2 is a block diagram of system 100 in examples of the present disclosure. To better illustrate the link monitoring technique, assume non-default MDC part 116B on member device 104 is allocated uplink ports U1 and U2 to upstream network 110, downlink ports D1, D2, and D3 to downstream network 112, and a stacking port S (e.g., an IRF stacking port) to non-default MDC part 116A on member device 102. Downlink ports D1 and D2 may be classified as the same type based on user, traffic, or other criteria. Downlink ports D1 and D2 may be associated with uplink port U1. For example, traffics received on downlink ports D1 and D2 are forwarded to uplink port U1. Downlink port D3 may be a different type than downlink ports D1 and D2. Downlink port D3 may be associated with uplink port U2. For example, traffic received on downlink port D3 is forwarded to uplink port U2.

A link monitor group is configured for each type of downlink port. Each link monitor group has a monitor port and two control groups. Once the monitor port changes from the up state to the down state, ports in the two control groups may continue to operate when both control groups are in the up state. When one control group is in the down state, changes are made so all ports in both control groups are in the down state. For example, all ports are changed to the down state or ports that are in the up state are changed to the down state. When one control group is empty (does not have any ports), changes are made so all ports in the other control group are in the down state. When the monitor port recovers from the down state to the up state, changes are made so all ports in both control groups are in the up state. For example, all ports are changed to the up state or ports that are in the down state are changed to the up state. In one example, a control group is in the up state when all ports in the control group is in the up state, and the control group is in the down state when one or more ports in the control group are in the down state. In another example, a control group is in the up state when at least one port in the control group is in the up state, and the control group is in the down state when all the ports in the control group are in the down state. A link monitor group may be formed by assigning a stacking port as the monitor port, assigning ports to the control groups, and binding or otherwise associating the monitor port and the control groups with each other.

Stacking port S may be set as the monitor port. One or more downlink ports of the same type are assigned to one control group (also referred to as “downlink port group”), and any uplink ports associated with one of the downlink ports are assigned to the other control group (also referred to as “uplink port group”). For example, a link monitor group 202 may be created for downlink ports D1 and D2. In link monitor group 202, stacking port S is selected as the monitor port, downlink ports D1 and D2 are assigned to the downlink port group, and uplink port U1 is assigned to the uplink port group. A link monitor group 204 may be created for downlink port D3. In link monitor group 204, stacking port S is selected as the monitor port, downlink port D3 is assigned to the downlink port group, and uplink port U2 is assigned to the uplink port group.

In examples where there are more than two member devices, a non-default MDC part has more than one stacking port, and a link monitor group is configured for each type of downlink port for every stacking port.

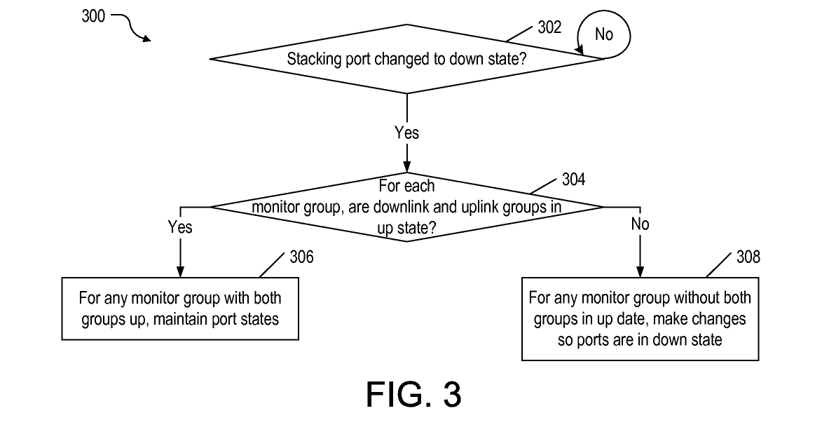

FIG. 3 is a flowchart of a method 300 for a non-default MDC part on a member device of a virtual device in a system (also referred to as one “side” of the non-default MDC device), such as non-default MDC part 116B on member device 104 of virtual device 108 in system 100, to use link monitoring to handle stacking link failures in examples of the present disclosure. Method 300 may begin in block 302.

In block 302, non-default MDC part 116B monitors the state of stacking port S and determines if stacking port S has changes from the up state to the down state. If so, block 302 may be followed by block 304. Otherwise block 302 may loop back to itself to continue monitoring stacking port S.

In block 304, non-default MDC part 116B determines link monitor groups that have stacking port S as their monitor port. For example, non-default MDC part 116B finds link monitor groups 202 and 204 (FIG. 2). Non-default MDC part 116B then loops through each such link monitor group to determine if both the downlink and the uplink port groups in the link monitor group are in the up state. If so, block 304 may be followed by block 306 for that link monitor group. Otherwise block 304 may be followed by block 308 for that link monitor group. As discussed above, in one example, a port group is in the up state when all ports in the group are in the up state, or otherwise the group is in the down state. In another example, a port group is in the up state when at least one port in the group is in the up state, or otherwise the group is in the down state.

In block 306, for each link monitor group that has both groups up, non-default MDC part 116B maintains the states of all the ports in the downlink and the uplink port groups in such link monitor group.

In block 308, for each link monitor group that does not have both groups in the up state, non-default MDC part 116B makes changes so all port in the downlink and the uplink port groups of such link monitor group are in the down state. For example, any port that is in the up state is changed to the down state.

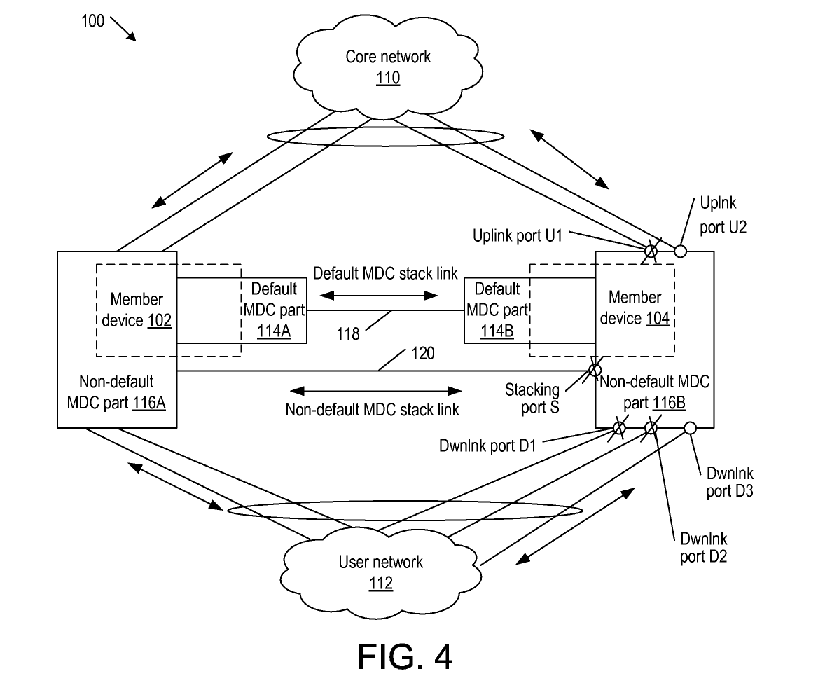

FIG. 4 is a block diagram illustrating a scenario where non-default MDC part 116B of system 100 practices method 300 (FIG. 3) in examples of the present disclosure. In this example, a port group is in the up state when all ports in the group are in the up state, or otherwise the group is in the down state. Assume the stacking port S has changes from the up state to the down state. In response, non-default MDC part 116B determines the states of the downlink and the uplink port groups of link monitor groups 202 and 204 (FIG. 2).

Assume that downlink port D1 is in the down state, downlink port D2 is in the up state, and uplink port U1 is in the up state. This means the downlink port group of link monitor group 202 is in the down state while the uplink port group of link monitor group 202 is in the up state. In response, non-default MDC part 116B changes downlink port D2 and uplink port U1 from the up state to the down state.

Assume that downlink port D3 is in the up state and uplink port U2 is in the up state. This means the downlink and the uplink port groups of link monitor group 204 are in the up state. In response, non-default MDC part 116B maintains the states of downlink port D3 and uplink port U2.

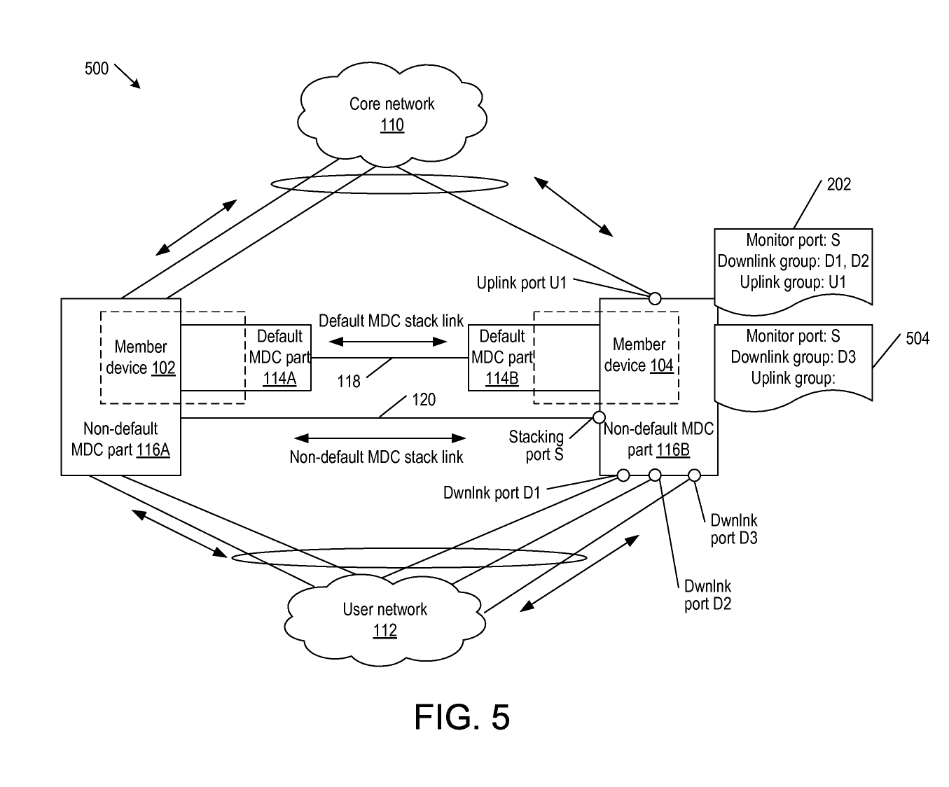

In some examples, the uplink port group of a link monitor group may be empty because no uplink port is associated with any of the downlink ports in the downlink port group of the link monitor group. FIG. 5 is a block diagram of a system 500 illustrating this scenario in examples of the present disclosure. System 500 is similar to system 100 (FIG. 2) except uplink port U2 (FIG. 2) has not been allocated to non-default MDC part 116B so that the uplink port group of a link monitor group 504 is empty. When non-default MDC part 116B receives traffic from downlink port D3, it forwards the traffic over stacking link 120 to non-default MDC part 116A.

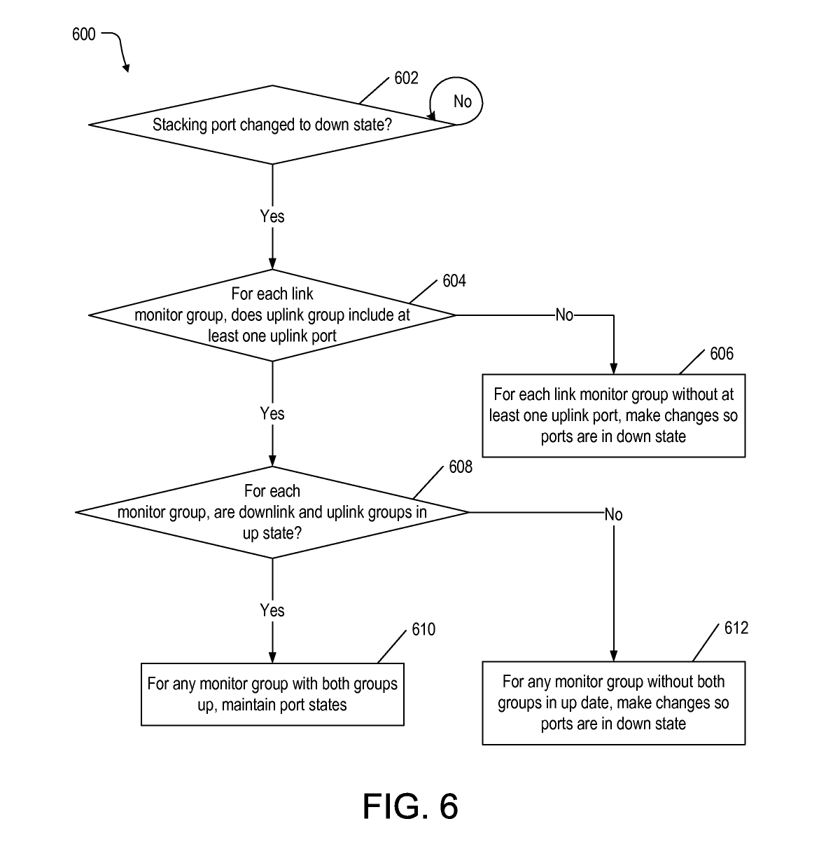

FIG. 6 is a flowchart of a method 600 for a non-default MDC part on a member device of a virtual device in a system, such as non-default MDC part 116B on member device 104 of virtual device 108 in system 500, to use link monitoring to handle stacking link failures in examples of the present disclosure. Method 600 may begin in block 602.

In block 602, non-default MDC part 116B monitors the state of stacking port S and determines if stacking port S has changes from the up state to the down state. If so, block 602 may be followed by block 604. Otherwise block 602 may loop back to itself to continue monitoring stacking port S.

In block 604, non-default MDC part 116B determines link monitor groups that have stacking port S as their monitor port. For example, non-default MDC part 116B finds link monitor groups 202 and 504 (FIG. 5). Non-default MDC part 116B then loops through each such link monitor group to determine if the uplink port group in the link monitor group includes at least one uplink port. If no, block 604 may be followed by block 606 for that link monitor group. Otherwise block 604 may be followed by block 608 for that link monitor group.

In block 606, for each link monitor group that does not have at least one uplink port, non-default MDC part 116B makes changes so all ports in the downlink port group of such link monitor group are in the down state. For example, all the ports are changed to the down state. Block 606 may loop back to block 602.

In block 608, non-default MDC part 116B loops through each such link monitor group to determine if both the downlink port group and the uplink port group in the link monitor group are up. If so, block 608 may be followed by block 610 for that link monitor group. Otherwise block 608 may be followed by block 612 for that link monitor group. As discussed above, in one example, a port group is in the up state when all ports in the group are in the up state, or otherwise the group is in the down state. In another example, a port group is in the up state when at least one port in the group is in the up state, or otherwise the group is in the down state.

In block 610, for each link monitor group that has both groups up, non-default MDC part 116B maintains the states of all the ports in the downlink and the uplink port groups in such link monitor group.

In block 612, for each link monitor group that does not have both groups in the up state, non-default MDC part 116B makes changes so all port in the downlink and the uplink port groups of such link monitor group are in the down state. For example, any port that is in the up state is changed to the down state.

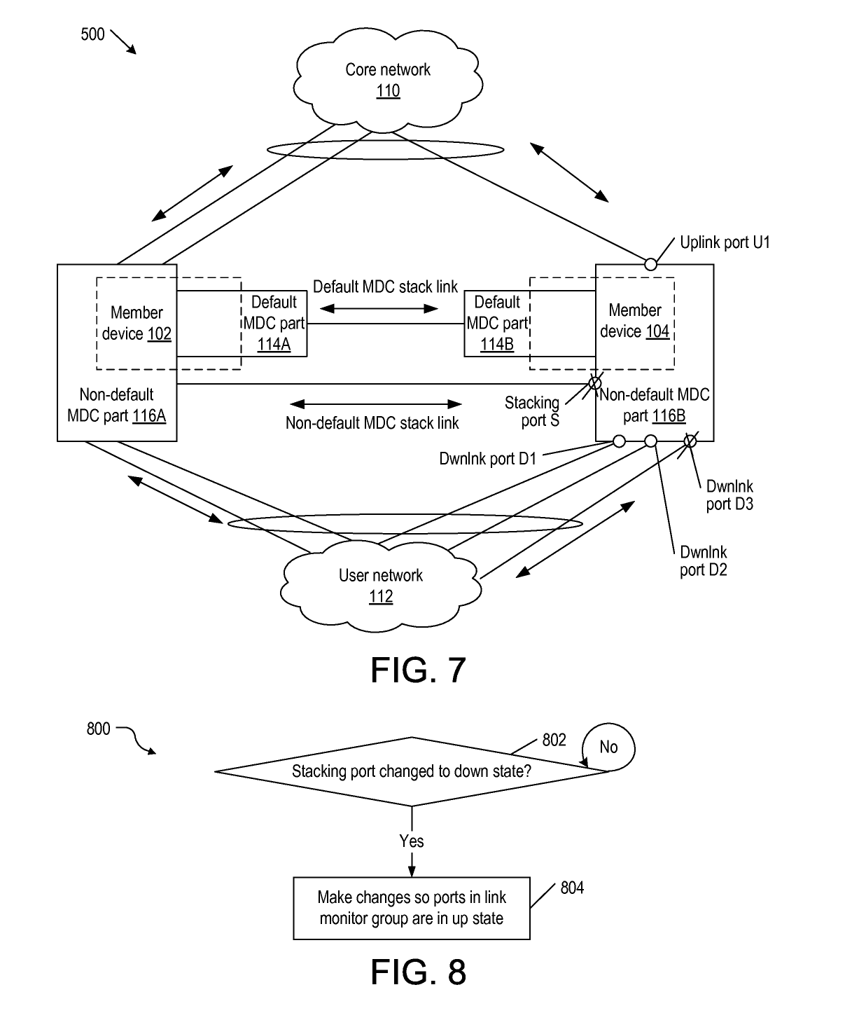

FIG. 7 is a block diagram illustrating a scenario where non-default MDC part 116B on member device 104 of system 500 practices method 600 (FIG. 6) in examples of the present disclosure. In this example, a port group is in the up state when all ports in the group are in the up state, or otherwise the group is in the down state. Assume the stacking port S has changes from the up state to the down state. In response, non-default MDC part 116B determines if the uplink port group of each link monitor group has least one uplink port. Non-default MDC part 116B finds that the uplink port group of link monitor group 504 (FIG. 5) does not have at least one uplink port. Assuming that downlink port D3 is in the up state, non-default MDC part 116B changes downlink port D3 to the down state.

Non-default MDC part 116B then determines the states of the downlink and the uplink port groups of link monitor group 202 (FIG. 5). Assume that downlink ports D1 and D2 are in the up state, and uplink port U1 is in the up state. This means the downlink and the uplink port groups of link monitor group 202 are in the up state. In response, non-default MDC part 116 maintains the states of downlink ports D1, D2 and uplink port U1.

In some examples, a stacking link recovers from the down state to the up state. For example, FIG. 4 shows system 100 in a state where stacking port S, downlink ports D1, D2, and uplink port U1 are in the down states. When stacking port S recovers, non-default MDC part 116B may make changes so all the ports in link monitor groups 202 and 204 (FIG. 2) are in the up state so they may forward traffic. System 500 (FIG. 5) may operate in a similar manner as system 100.

FIG. 8 is a flowchart of a method 800 for a non-default MDC part on a member device of a virtual device in a system, such as non-default MDC part 116B on member device 104 of virtual device 108 in system 100, to use link monitoring to handle stacking link recoveries in examples of the present disclosure. Method 800 may begin in block 802.

In block 802, non-default MDC part 116B monitors the state of stacking port S and determines if stacking port S has changes from the down state to the up state. If so, block 802 may be followed by block 804. Otherwise block 802 may loop back to itself to continue monitoring stacking port S.

In block 804, non-default MDC part 116B determines link monitor groups that have stacking port S as their monitor port. For example, non-default MDC part 116B finds link monitor groups 202 and 204 (FIG. 2). Non-default MDC part 116B may then make changes so the states of all the ports in link monitor groups 202 and 204 are in the up state. For example, all ports are changed to the up state. As a result, system 100 returns to the state shown in FIG. 2.

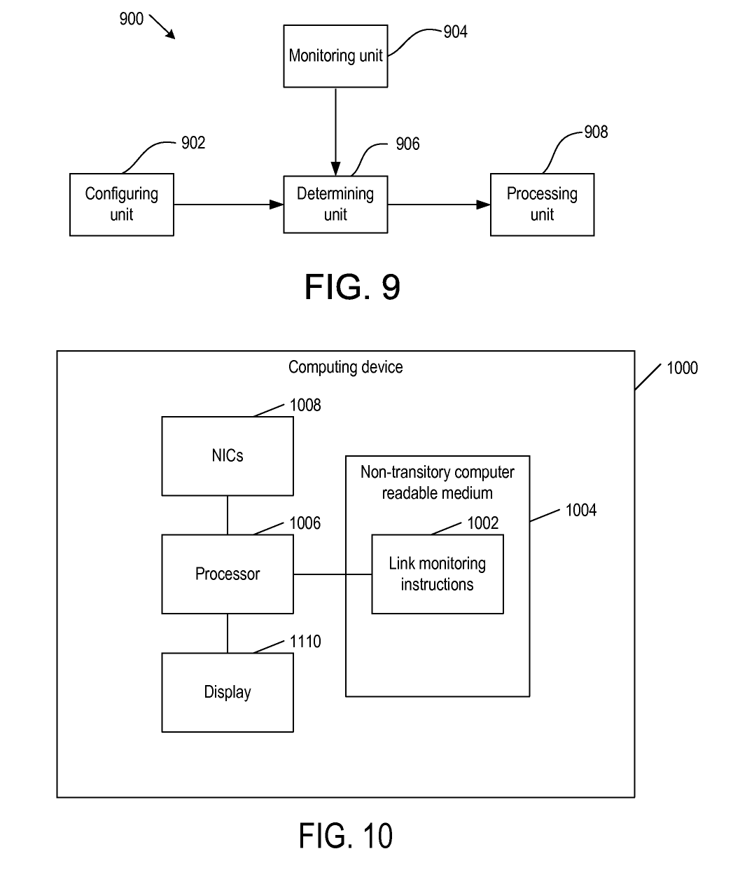

FIG. 9 is a block diagram of an apparatus 900 to implement a non-default MDC part on a member device of a virtual device in examples of the present disclosure. Apparatus 900 includes a configuring unit 902, a monitoring unit 904, a determining unit 906, and a processing unit 908.

Configuring unit 902 is to assign stacking ports, downlink ports, and uplink ports to link monitor groups. As discussed above, a link monitor group may be created for each type of downlink port. If more than one stacking port is present, a link monitor group is created for each type of downlink port for every stacking port.

Monitoring unit 904 is to monitor the state of the monitor ports of the link monitor groups at the non-default MDC part.

Determining unit 906 is to find the link monitor groups with a particular monitor port (i.e., a particular stacking port) and determine the states of the downlink and the uplink port groups in such link monitor groups when the monitor port changes to the down state, which is determined by monitoring unit 904.

Processing unit 908 is to track the states of the uplink and the downlink port groups in the link monitor groups, which are provided by determining unit 906. When a particular stacking port changes to the down state, processing unit 908 may take one of the following actions on each link monitor group that has the stacking port as its monitor port. When the link monitor group does not have both the uplink and the downlink port groups in the up state, processing unit 908 is to change the state of any port in that link monitor group from the up state to the down state. When the link monitor group has both the uplink and the downlink port groups in the up state, processing unit 908 is to maintain the states of the ports in that link monitor group. When the stacking port recovers to the up state, processing unit 908 is to change the states of all the ports in the link monitor group to the up state.

When a particular stacking port changes to the down state, determining unit 906 and processing unit 908 may also take the following actions on each link monitor group that has the stacking port as its monitor port. Determining unit 906 determines if the uplink port group of the link monitor group is empty. If the uplink port group of the link monitor group is empty, processing unit 908 is to change all the ports in the downlink port group to the down state.

FIG. 10 is a block diagram of a computing device 1000 for implementing a non-default MDC part on a member device of a virtual device in examples of the present disclosure. A link monitor is implemented with processor executable instructions 1002 stored in a non-transitory computer medium 1004, such as hard disk drive, a solid state drive, or another nonvolatile computer memory. A processor 1006 executes instructions 1002 to provide the described features and functionalities, which may be implemented by sending instructions to a network interface 1008 or a display 1010.

Various other adaptations and combinations of features of the examples disclosed are within the scope of the invention. For example, although IRF is provided as an example for network device stacking or virtualization, other technologies may be used.

What is claimed is:

1: A method for a first part of a non-default multitenant device context (MDC) device on a first member device of a logical network device, comprising:
assigning a first downlink port of the first part of the non-default MDC device to a first downlink port group;
assigning a first uplink port of the first part of the non-default MDC device to a first uplink port group associated with the first downlink port group;
monitoring a stacking port of the first part of the non-default MDC device connected to a second part of the non-default MDC device on a second member device of the logical network device;
when the stacking port changes to a down state, determining if the first downlink port group and the first uplink port group are both in an up state;
when the first downlink port group and the first uplink port group are both in the up state, maintaining ports in the first downlink port group and the first uplink port group in the up state; and
when the first downlink port group and the first uplink port group are not both in the up state, making changes so the ports in the first downlink port group and the first uplink port group are in the down state.

2: The method of claim 1, wherein a port group is in the up state when all ports in that port group are in the up state.

3: The method of claim 1, further comprising, when the stacking port recovers to the up state:
making changes so ports in the first downlink port group and the first uplink port group are in the up state.

4: The method of claim 1, further comprising:
assigning a second downlink port of the first part of the non-default MDC device to a second downlink port group; and
when the stacking port changes to the down state:
determining there is no uplink port associated with any port in the second downlink port group; and
making changes so ports in the second downlink port group are in the down state.

5: The method of claim 4, further comprising, when the stacking port recovers to the up state:
making changes so ports in the first downlink port group, the first uplink port group, and the second downlink port group are in the up state.

6: The method of claim 1, wherein:
the logical network device is virtualized into a default MDC device and at least the non-default MDC device;
at least one of downlink aggregation and uplink aggregation being applied to non-default MDC device;
the default MDC device shares a default MDC stacking link with the non-default MDC device;
the non-default MDC device uses the default MDC stacking link as a control link;
the non-default MDC device uses a non-default MDC stacking link connected to the stacking port as a data link; and
the first part of the non-default MDC device prefers to forward traffic on its side of the non-default MDC device.

7: A member device of a logical network device to form a part of a non-default multitenant device context (MDC) device, the member device comprising:
a configuring unit to:
assign a first downlink port of the part of the non-default MDC device to a first downlink port group; and
assign a first uplink port of the part of the non-default MDC device to a first uplink port group associated with the first downlink port group;
a monitoring unit to monitor a stacking port of the part of the non-default MDC device;
a determining unit to determine if the first downlink port group and the first uplink port group are both in the up state when the monitoring unit detects that the stacking port changed to the down state, wherein a port group is up when all ports in that port group are up and otherwise the port group is down; and
a processing unit to:
when the first downlink port group and the first uplink port group are both in the up state, maintain ports in the first downlink port group and the first uplink port group in the up state; and
when the first downlink port group and the first uplink port group are not both in the up state, make changes so the ports in the first downlink port group and the first uplink port group are in the down state.

8: The member device of claim 7, wherein port group is in the up state when all ports in that port group are in the up state.

9: The member device of claim 7, wherein:
the monitoring unit is further to detect that the stacking port has recovered to the up state; and
when the monitoring unit detects that the stacking port has recovered to the up state, the processing unit is further to make changes so ports in the first downlink port group and the first uplink port group are in the up state.

10: The member device of claim 7, wherein:
the configuring unit is further to assign a second downlink port of the part of the non-default MDC device to a second downlink port group; and
the processing unit is further to, when the monitoring unit detects that the stacking port changed to the down state:
determine there is no uplink port associated with any port in the second downlink port group; and
make changes so ports in the second downlink port group are in the down state.

11: The member device of claim 10, wherein:
the monitoring unit is further to detect that the stacking port has recovered to the up state; and
when the monitoring unit detects that the stacking port has recovered to the up state, the processing unit is further to make changes so ports in the first downlink port group, the first uplink port group, and the second downlink port group are in the up state.

12: The member device of clam 7, wherein:
the logical network device is virtualized into a default MDC device and at least the non-default MDC device;
at least one of downlink aggregation and uplink aggregation being applied to the non-default MDC device;
the default MDC device shares a default MDC stacking link with the non-default MDC device;
the non-default MDC device uses the default MDC stacking link as a control link;
the non-default MDC device uses a non-default MDC stacking link connected to the stacking port as a data link; and
the part of the non-default MDC device prefers to forward traffic on its side of the non-default MDC device.

13: A non-transitory computer readable medium encoded with executable instructions for execution by a processor to:
monitor a stacking port of a part of a logical network device, the stacking port connecting the part of the logical network device to another part of the logical network device; and
when the stacking port changes to a down state, change or maintain states of associated downlink and uplink ports of the part of the logical network device based on the states of the associated downlink and uplink ports, the associated downlink and uplink ports connecting the part of the logical network device to downstream and upstream networks.

14: The medium of claim 13, wherein the processor is to maintain the states of the associated downlink and uplink ports when all the downlink and the uplink ports are in the up state.

15: The medium of claim 13, further comprising executable instructions for execution by the processor to:
when the stacking port changes to a down state, change states of downlink ports on the part of the logical network device that does not have any associated uplink ports.
